(19) United States
(12) Patent Application Publication
(10) Pub. No.: US 2025/0309426 A1
(43) Pub. Date: Oct. 2, 2025

(54) CELL-SEATING UNIT AND BATTERY MODULE COMPRISING THE SAME

(71) Applicant: SK ON CO., LTD., Seoul (KR)

(72) Inventors: Sun Mo AN, Daejeon (KR); Gyu Jin CHUNG, Daejeon (KR)

(21) Appl. No.: 19/238,543

(22) Filed: Jun. 16, 2025

Related U.S. Application Data
(63) Continuation of application No. 17/060,209, filed on Oct. 1, 2020.

(30) Foreign Application Priority Data
Nov. 1, 2019 (KR) 10-2019-0138857

(51) Int. Cl. H01M 50/20; H01M 10/613; H01M 10/625; H01M 10/6555

(52) U.S. Cl. CPC H01M 50/20; H01M 10/613; H01M 10/625; H01M 10/6555; H01M 2220/20

(57) ABSTRACT

A cell-seating unit may include a lower plate member in which a secondary battery cell is seated while being in contact with a side surface portion of the secondary battery cell; an upper plate member disposed to face the lower plate member; and a middle plate member coupled to the lower plate member and the upper plate member for connection thereof while being in contact with a bottom portion of the secondary battery cell.

### CROSS-REFERENCE TO RELATED APPLICATION

This application is a continuation of U.S. patent application Ser. No. 17/060,209 filed on Oct. 1, 2020, which claims priority to Korean Patent Application No. 10-2019-0138857 filed Nov. 1, 2019, the disclosure of which is hereby incorporated by reference in its entirety.

### BACKGROUND

### 1. Field of the Invention

The present disclosure relates to a cell-seating unit and a battery module including the same.

### 2. Description of Related Art

With increased demand for mobile devices, electric vehicles, and the like, along with the development of related technologies, demand for a secondary battery cell as an energy source has rapidly increased. A secondary battery cell may be repeatedly charged and discharged as mutual conversion between chemical energy and electrical energy is reversible in a secondary battery.

Such a secondary battery cell includes an electrode assembly of an anode, a cathode, a separation film, and an electrolyte solution, the main components of a secondary battery, and a cell body member of a multilayer laminated film case for protecting the same.

However, such an electrode assembly may generate heat while undergoing the process of charging and discharging, and a temperature rise due to the generated heat may deteriorate performance of the secondary battery cell.

In this regard, a housing member accommodating a secondary battery cell and a heat sink in contact therewith have conventionally been suggested to cool the secondary battery cell.

There has been, however, a limitation that cooling performance may be deteriorated by the heat sink disposed on an exterior of the housing member.

In another aspect, the secondary battery cell is conventionally installed, such that a bottom portion stands to be in contact with a lower plate member of the housing member, thereby making it difficult to change a height direction design.

In addition, to increase a number of secondary battery cells installed to increase energy density, the housing member needs to be extended in a width direction, thus disabling effective space use and leading to a limitation that an additional structure is required for rigidity compensation.

Accordingly, to resolve the above limitations, research into a cell-seating unit and a battery module including the same has been conducted.

### SUMMARY OF THE INVENTION

An aspect of the present disclosure is to provide a cell-seating unit for obtaining a degree of freedom in height direction design changes when accommodating a secondary battery cell and a battery module including the same.

Another aspect is to provide a cell-seating unit for reinforcing rigidity by a structure thereof without an additional configurational element and a battery module including the same.

According to an example embodiment of the present disclosure, a cell-seating unit may include a lower plate member in which a secondary battery cell is seated while being in contact with a side surface portion of the secondary battery cell; an upper plate member disposed to face the lower plate member; and a middle plate member coupled to the lower plate member and the upper plate member for connection thereof while being in contact with a bottom portion of the secondary battery cell.

The middle plate member of the cell-seating unit according to an example embodiment may be provided with a heat sink configured to release heat transferred from the secondary battery cell.

The middle plate member of the cell-seating unit according to an example embodiment may include the lower plate member and the upper plate member, facing each other in parallel, vertically coupled to both end portions thereof.

According to another example embodiment, a battery module may include a plurality of secondary battery cells; a cell-seating unit equipped with at least one of the secondary battery cells in a procumbent state; a cover unit coupled to the cell-seating unit and covering an opening of the cell-seating unit in which the secondary battery cells are accommodated.

The cell-seating unit of the battery module according to the another example embodiment may include a lower plate member in which a secondary battery cell is seated while being in contact with a side surface portion of a lowermost secondary battery cells; an upper plate member disposed to face the lower plate member; and a middle plate member coupled to the lower plate member and the upper plate member for connection thereof while being in contact with a bottom portion of the secondary battery cells.

The middle plate member of the battery module may be provided with a heat sink configured to release heat transferred from the secondary battery cells.

The middle plate member of the battery module may include the lower plate member and the upper plate member, facing each other in parallel, vertically coupled to both end portions thereof.

The cell-seating unit of the battery module according to the another example embodiment may be provided with the middle plate member at a height corresponding to a stacking height of a plurality of the secondary battery cells stacked to be accommodated and accommodate a plurality of the secondary battery cells in a region formed by the lower plate member, the upper plate member and the middle plate member.

Further, the middle plate member of the battery module may be coupled to the bottom portion of the secondary battery cells, mediated by a thermally conductive member.

In this case, the thermally conductive member may be formed to have a shape corresponding to a shape of the bottom portion of the secondary battery cells to support the secondary battery cells.

The thermally conductive member may be formed of at least one of silicon, polyurethane and an epoxy material such that the secondary battery cells are bonded thereto.

The cover unit of the battery module may include an end cover member coupled to both end portions of the middle plate member; and a side cover member disposed to face the middle plate member and coupled to edge portions of the upper plate member and the lower plate member.

Further, both end portions of the side cover member of the battery module may be inserted into coupling grooves formed in the upper plate member and the lower plate member.

In addition, the side cover member of the battery module may be provided with a coupling tab protruded from both end portions thereof in the form corresponding to the coupling groove.

The side cover member of the battery module may be provided with support tabs formed to protrude in a direction of the secondary battery cells, such that a plurality of the secondary battery cells are stacked and accommodated in the cell-seating unit. The plurality of the spaced apart tabs do not extend in an entire length of the side surfaces of secondary battery cells so that the secondary battery cells are spaced apart from each other with a void space between the side surfaces of adjacent secondary battery cells, and the void space is enclosed by the secondary battery cells and the spaced-apart tabs located on the thermally conductive member and the side cover member, respectively.

The cell-seating unit of the battery module may be disposed by stacking a pouch-type secondary battery cell three-surface-sealing and accommodating an electrode assembly.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a front view of a cell-seating unit of the present disclosure and a battery module including the same;

FIG. 2 is a perspective view of a disassembly of a cell-seating unit and a battery module including the same;

FIG. 3 is a perspective view of a disassembly of a cell-seating unit of the present disclosure and a battery module including the same;

FIG. 4 is a front view of an example embodiment in which a cover unit includes a support tab in a cell-seating unit and a battery module including the same;

FIG. 5 is a front view of an example embodiment in which a cell-seating has a “π” shape in a cell-seating unit and a battery module including the same; and

FIG. 6 is a front view of an example embodiment in which a coupling groove is formed in a cell-seating unit and a battery module including the same.

### DETAILED DESCRIPTION

Hereinafter, example embodiments of the present disclosure will be described with reference to the accompanying drawings. The present disclosure is not limited to example embodiments, and it is to be understood that modifications can be made without departing from the spirit and scope of the present disclosure. Shapes and sizes of the elements in the drawings may be exaggerated for clarity of description.

In addition, an expression used in the singular encompasses the expression of the plural, unless it has a clearly different meaning in context. Identical or corresponding elements will be given the same reference numerals.

The present disclosure relates to a cell-seating unit and a battery module including the same. A degree of freedom in height direction design changes can be secured when accommodating a secondary battery cell C, which may increase efficiency in space utilization when installing the secondary battery cell C.

In another aspect, a cell-seating unit 10 and a battery module including the same can have reinforced rigidity due to a structure thereof without any configurational addition, which may serve to secure durability while reducing an overall weight thereof.

Further, the cell-seating unit 10 and a battery module including the same can have improved heat dissipation performance due to a heat sink 13a, and this may enable a larger number of secondary battery cells C to be installed for a higher energy density. Further, outbreak of fire caused by heat from the secondary battery cells C may be reduced.

The secondary battery cell C may include an electrode assembly and a cell body member surrounding the electrode assembly.

The electrode assembly, together with an electrolyte substantially included therein, is accommodated in the cell body member to be used. The electrolyte may include a lithium salt, such as LiPF₆, LiBF₄, or the like, in an organic solvent, such as thylene carbonate (EC), propylene carbonate (PC), diethyl carbonate (DEC), ethylmethyl carbonate (EMC), and dimethyl carbonate (DMC). Further, the electrolyte may be a liquid, solid or gel phase.

In addition, the cell body member is an element for protecting the electrode assembly and accommodating the electrolyte. As an example, the cell body member may be provided as a pouch-type member or a can-type member. The pouch-type member is in the form in which the electrode assembly is three-surface sealed to be accommodated. The pouch-type member is a member configured to fold and bond three surfaces—an upper surface and side surfaces, excluding one surface, mostly a lower surface—to seal while having the electrode assembly accommodated therein. The can-type member is in the form in which the electrode assembly is one-surface sealed to be accommodated. The can-type member is a member configured to fold and bond one surface—the upper surface excluding three surfaces, mostly the lower surface and the side surfaces—to seal while having the electrode assembly accommodated therein.

Such a pouch-type or can-type secondary battery cell C is merely an example of a secondary battery cell accommodated in the cell-seating unit 10 and the battery module of the present disclosure, and the secondary battery cell C accommodated in the cell-seating unit 10 and the battery module of the present disclosure is not limited thereto.

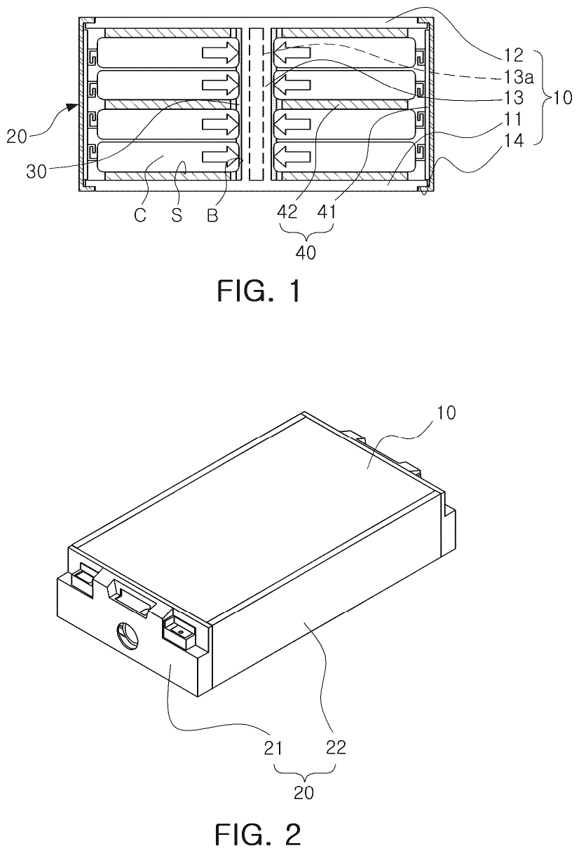

Specifically with reference to the drawings, FIG. 1 is a front view of a cell-seating unit of the present disclosure and a battery module including the same. Referring to FIG. 1, a cell-seating unit 10 according to an example embodiment may include a lower plate member 11 in which the secondary battery cell C is accommodated while being in contact with a side surface portion S of the secondary battery cell C; a upper plate member 12 disposed to face the lower plate member 11; and a middle plate member 13 coupled to the lower plate member 11 and the upper plate member 12 for connection thereof while being in contact with the bottom portion B of the secondary battery cell C.

That is, the cell-seating unit 10 of the present disclosure is suggesting a structure in which the side surface portion S of the secondary battery cell C is in contact with the lower plate member 11 and the bottom portion B is in contact with the middle plate member 13. As an example, in the cell-seating unit 10, the secondary battery cell C is configured to be inserted into a space formed by the lower plate member 11, the upper plate member 12 and the middle plate member 13 in a procumbent state. In this case, the cell-seating unit 10 may be formed of a material such as aluminum (Al), steel (Fe), or the like.

According to the above, in the case in which a plurality of the secondary battery cells C are installed, the secondary battery cells C can be stacked in the height direction of the cell-seating unit 10, and can thus secure a degree of freedom in height direction design changes of the cell-seating unit 10.

The lower plate member 11 is an element disposed in a lower portion of the cell-seating unit 10 and is seated to have the secondary battery cell in a procumbent state. The lower plate member 11 may be disposed to face the upper plate member 12 and may be bonded such that the middle plate member 13 is disposed between the upper plate member 12 and the lower plate member 11.

The lower plate member 11 may be seated to have the secondary battery cell C in a procumbent state such that the side surface portion S of the secondary battery cell C is in contact therewith. In the case in which a plurality of the secondary battery cells C are stacked, a side surface portion S of a lowermost secondary battery cell C is in contact with the lower plate member 11.

The upper plate member 12 may be disposed to face the lower plate member 11 and be in contact with the side surface portion S of the secondary battery cell C. In the case in which a plurality of the secondary battery cells C are provided, the upper plate member 12 is in contact with a side surface S of an uppermost secondary battery cell C.

A pad member 40 is disposed between the lower plate member 11 and the secondary battery cell C and between the upper plate member 12 and the secondary battery cell C to serve to absorb a volume change due to swelling of the secondary battery cell C. Specifically, a side pad 42 of the pad member 40 may be disposed between the lower plate member 11 and the side surface portion S of the lowermost secondary battery cell C or between the upper plate member 12 and the side surface portion S of the uppermost secondary battery cell C.

Alternately, the side pad 42 may be disposed between a plurality of the stacked secondary battery cells C even when not in contact with the upper plate member 12 or the lower plate member 11 to absorb a volume change due to the swelling of the secondary battery cell C.

The middle plate member 13 is an element bonding the lower plate member 11 and the upper plate member 12 and forms a space accommodating the lower plate member 11, the upper plate member 12 and the secondary battery cell C.

As an example, the middle plate member 13 of the cell-seating unit 10 according to an example embodiment features in that the lower plate member 11 and the upper plate member 12 horizontally facing each other are vertically bonded to both end portions of the middle plate member 13.

In other words, the middle plate member 13 is vertically disposed, and the lower plate member 11 and the upper plate member 12 are parallel to each other and bonded to both end portions of the middle plate member 13.

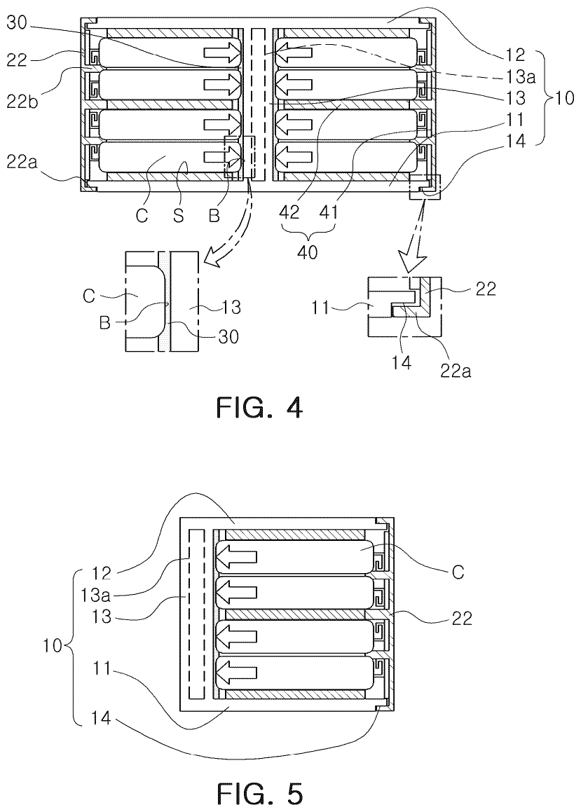

More specifically, the middle plate member 13 is bonded to a central portion between the upper plate member 12 and the lower plate member 11 to form a “I” shape or to an edge portion of the upper plate member 12 to form a “π” shape, which will be described in detail with reference to FIGS. 4 to 6 below.

Further, the middle plate member 13 may be disposed to be in contact with the bottom portion B of the secondary battery cell C, so as to receive heat H generated by the secondary battery cell C and to release heat H externally through the heat sink 13a.

That is, the middle plate member of the cell-seating unit 10 according to an example embodiment is provided with a sink 13a releasing heat externally generated by the heat secondary battery cell C.

As an example, the heat sink 13a may be configured to externally release heat released from the secondary battery cell C using a flowing cooling fluid. That is, when a cooling fluid having a lower temperature than the secondary battery cell C flows inside the middle plate member 13 and receives the heat H generated by the secondary battery cell C to turn into a high-temperature cooling fluid, the heat sink 13a allows the cooling fluid to flow out externally having a lower temperature than the secondary battery cell C and releases the heat followed by circulating the heat in the direction of the secondary battery cell C, thereby releasing the heat H of the secondary battery cell C externally.

However, the heat sink 13a is not limited to such a configuration, and any heat sink for externally releasing heat H transferred from the secondary battery cell C can be the heat sink 13a of the present disclosure.

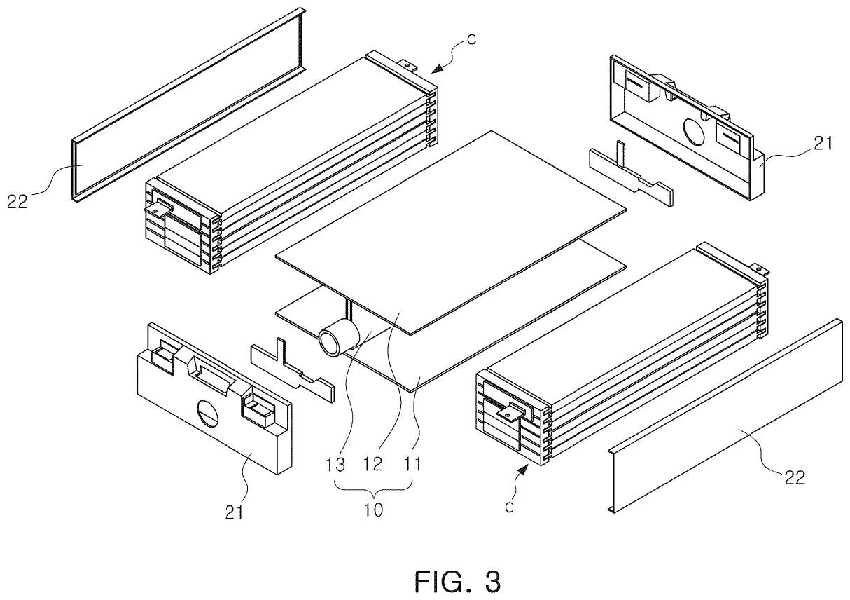

FIG. 2 is a perspective view of a disassembly of a cell-seating unit and a battery module including the same, and FIG. 3 is a perspective view of a disassembly of a cell-seating unit of the present disclosure and a battery module including the same.

Referring to FIGS. 2 and 3, a battery module according to another example embodiment may include a plurality of secondary battery cells C, a cell-seating unit 10 equipped with at least one of the secondary battery cells C in a procumbent state, and a cover unit 20 coupled to the cell-seating unit 10 and covering an opening of the cell-seating unit 10 accommodating the secondary battery cells C.

As the above, the battery module of the present disclosure, by including the cell-seating unit 10, can accommodate the secondary battery cells C in a procumbent state. In addition, in the case in which a plurality of the secondary battery cells C are accommodated, a plurality of the secondary battery cells C are stacked in a height direction of the cell-seating unit 10 to be accommodated.

This may enable the battery module of the present disclosure including the cell-seating unit 10 to secure a degree of freedom in height direction design changes when accommodating the secondary battery cells C and to be designable to be suitable to a device, such as an electric vehicle, or the like, in which the battery module is installed.

That is, the cell-seating unit 10 of the battery module according to another example embodiment includes the middle plate member 13 at a height corresponding to a stacking height of a plurality of the secondary battery cells C stacked to be accommodated, and can thus accommodate a plurality of the secondary battery cells C in a space formed by the lower plate member 11, the upper plate member 12 and the middle plate member 13.

In other words, a length of the middle plate member 13 having both end portions to which the lower plate member 11 and the upper plate member 12 are coupled is designed to be adjusted, thereby securing a degree of freedom in a height direction of the cell-seating unit 10. This is a practical design due to the secondary battery cells C mounted in a procumbent state and the cell-seating unit 10 stacked in a height direction when mounting a plurality of the secondary battery cells C.

That is, when the secondary battery cells C are mounted in a standing state, a cell-seating member needs to be designed limitedly correspondingly to a height of the secondary battery cells C. In contrast, the cell-seating unit 10 of the present disclosure is not limited to a height of the secondary battery cells C as the cell-seating unit 10 is configured to install the secondary battery cells in a procumbent state.

The cell-seating unit 10 of the battery module may be disposed by stacking a pouch-type secondary battery cells C accommodating the electrode assembly by three-surface sealing the same or a can-type secondary battery cells C accommodating the electrode assembly by one-surface sealing the same.

According to the above, a sealing portion of the cell body member, formed by sealing the electrode assembly of the secondary battery cells C are not formed in the bottom portion B of the secondary battery cells C, and accordingly, the bottom portion B in contact with the middle plate member 13 transfers the heat generated by the secondary battery cells C to the middle plate member 13.

Such a pouch-type or can-type secondary battery cell C is, however, merely an example of the secondary battery cells C accommodated in the battery module of the present disclosure, and the secondary battery cells C accommodated in the battery module is not limited thereto.

The cover unit 20, in cooperation with the cell-seating unit 10, serves to protect the secondary battery cells C accommodated in the cell-seating unit 10.

To this end, the cover unit 20 is disposed to cover an opening of the cell-seating unit 10, an entrance through which the secondary battery cells C are accommodated, and thus covers the secondary battery cells C in cooperation with the cell-seating unit 10. Specifically, the cover unit 20 may include a side cover member 20 surrounding a side surface portion of the cell-seating unit 10 and an end cover member 21 surrounding front and rear portions of the cell-seating unit 10.

That is, the cover unit 20 of the battery module according to another example embodiment may include the end cover member 21 bonded to both end portions of the middle plate member 13, and the side cover member 22 disposed to face the middle plate member 13 and bonded to the edge portions of the upper plate member 12 and the lower plate member 11.

In this case, a substrate, and a bus bar connected to an electrode tap of the secondary battery cells C may be disposed in the end cover member 21. The configurations of the bus bar and the substrate, disposed in the end cover member 21, may be subject to a design change to correspond to a case in which the secondary battery cells C are a multitap including a cathode tap and an anode tap formed in one end portion thereof or a case in which the secondary battery cells C are a single tap including a cathode tap formed in one end portion and an anode tap formed in the other end portion.

A top pad 41 of the pad member 40 for cushioning a collision with the secondary battery cells C may be disposed in the side cover member 22. That is, the bottom portion B of the secondary battery cells C are in contact with the middle plate member 13, and the sealing portion of the cell body member formed by sealing the electrode assembly of the secondary battery cells C are in contact with the side cover member 22. To prevent an error of an installation space and a collision with the secondary battery cells C, the top pad 41 is disposed in the side cover member 22.

In addition, a support tab 22b for stably supporting a plurality of the secondary battery cells C stacked in a height direction of the cell-seating unit 10 may be formed in the side cover member 22, which will be described in detail with reference to FIGS. 4 to 6.

Further, a coupling tap 22a coupled to a coupling groove 14 formed in the cell-seating unit 10 may be formed in the side cover member 22 for stable coupling with the cell-seating unit 10, which will be described in detail with reference to FIGS. 4 to 6.

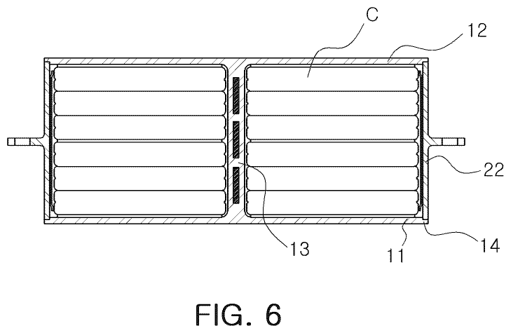

FIG. 4 is a front view of an example embodiment in which a cover unit includes a support tab in a cell-seating unit and a battery module including the same, and FIG. 5 is a front view of an example embodiment in which a cell-seating portion has a “π” shape in a cell-seating unit and a battery module including the same, while FIG. 6 is a front view of an example embodiment in which a coupling groove is formed in a cell-seating unit and a battery module including the same.

Referring to FIGS. 4 to 6, the cell-seating unit 10 according to another example embodiment is formed to have a “I” shape—the middle plate member 13 is coupled to a central portion of the lower plate member 11 and the upper plate member 12.

Alternately, the cell-seating unit 10 according to another example embodiment may be formed to have a “π” shape—the middle plate member is coupled to edge portions of the lower plate member 11 and the upper plate member 12.

That is, the middle plate member 13 may be disposed to form the “I” shape by being coupled to the central portion of the lower plate member 11 and the upper plate member 12 or “π” shape by being coupled to the edge portions of the lower plate member 11 and the upper plate member 12.

The cell-seating having the “I” shape is illustrated in FIG. 4 while that having the “π” shape is illustrated in FIG. 5.

The cell-seating unit 10 having the “I” shape is in the form in which the bottom portion B of the secondary battery cells C are in contact with and stacked on both side surface portions of the middle plate member 13, and the cell-seating unit 10 having the “π” shape is in the form in which the bottom portion B of the secondary battery cells C are in contact with and stacked on one side surface portion of the middle plate member 13 only.

The cell-seating unit 10 having the “I” shape may have an increased number of the secondary battery cells C stacked to be installed and thus is advantageous in that a battery module can be designed to have high energy density.

The cell-seating unit 10 having the “πn” shape is disposed such that the secondary battery cells C are only in contact with the one side surface portion of the middle plate member 13 including the heat sink 13a and thus is advantageous in that cooling efficiency for the secondary battery cells C can be increased.

Further, the middle plate member 13 of the battery module according to another example embodiment is coupled to the bottom portion B of the secondary battery cells C mediated by a thermally conductive member 30.

As the above, in the case in which the thermally conductive member 30 is provided, a contact ratio between the middle plate member 13 and the bottom portion B of the secondary battery cells C may be increased. That is, as the bottom portion B of the secondary battery cells C may not be flat, it may be difficult to be completely in contact with the middle plate member 13. However, this may be resolved by including the thermally conductive member 30.

This may serve to increase efficiency in transferring the heat generated by the secondary battery cells C to the middle plate member 13 including the heat sink 13a.

In this case, the thermally conductive member 30 of the battery module according to another example embodiment is formed to have a shape corresponding to a shape of the bottom portion B of the secondary battery cells C to support the secondary battery cells C.

This may enable a plurality of secondary battery cells C stacked in the cell-seating unit in a procumbent state in a height direction to be supported.

That is, as the thermally conductive member 30 is formed to have a shape corresponding to the bottom portion B of the secondary battery cells C enabling the bottom portion B of the secondary battery cells C to be inserted thereinto, a plurality of the secondary battery cells C stacked in a procumbent state in the height direction of the cell-seating unit 10 can be supported at a height, at which each secondary battery cell C is located.

In other words, a secondary battery cell C located in a lower portion, among a plurality of the secondary battery cells C stacked in the height direction of the cell-seating unit 10, is pressed by a secondary battery cell C disposed in an upper portion, which may create a problem in which the secondary battery cells C may rupture. In the present disclosure, however, each secondary battery cell C is supported by the thermally conductive member 30 in terms of weight, such a problem in which a secondary battery cell C positioned below a neighboring cell may be pressed and ruptured can be prevented.

The thermally conductive member 30 of the battery module according to another example embodiment may be formed of at least one of silicon, polyurethane, and an epoxy material to enable the secondary battery cells C to be bonded.

That is, the thermally conductive member 30 is coupled to the middle plate member 13 and the bottom portion B of the secondary battery cells C due to adhesion therebetween, and can thus be formed of such materials to support the secondary battery cells C by the adhesion.

However, the material of the thermally conductive member 30 is not limited thereto, and any adhesive material for transferring heat and an adhesive can be the thermally conductive member 30 of the present disclosure.

The side cover member 22 of the battery module according to another example embodiment has both end portions inserted into coupling grooves 14 formed in the upper plate member 12 and the lower plate member 11.

That is, due to the coupling grooves 14, the side cover member 22 can be firmly coupled to the upper plate member 12 and the lower plate member 11. The side cover member 22 can be coupled to the upper plate member 12 and the lower plate member 11 by applying an adhesive to the coupling grooves 14 or welding.

In addition, the side cover member 22 of the battery module according to another example embodiment is provided with a coupling tab 22a protruded from both end portions thereof in the form corresponding to the coupling groove 14.

Due to the coupling tab 22a, the side cover member 22 can be more firmly coupled to the upper plate member 12 and the lower plate member 11.

Further, as illustrated in FIG. 4, in the case in which the coupling tap 22a is disposed on a side more external than the edge portions of the lower plate member 11 and the upper plate member 12, resistance may be added when the lower plate member 11 and the upper plate member 12 are bent outwardly due to swelling of the secondary battery cells C. In this regard, deformations of the lower plate member 11 and the upper plate member 12 can be prevented while maintaining the coupling with the lower plate member 11 and the upper plate member 12.

Additionally, the side cover member 22 of the battery module according to another example embodiment includes a support tab 22a formed to protrude in a direction of the secondary battery cells C so as to support each secondary battery cell C accommodated in the cell-seating unit 10 to be stacked. The tabs do not extend in an entire length of the side surfaces of the secondary battery cells so that the secondary battery cells are spaced apart from each other with a void space between the side surfaces of adjacent secondary battery cells. The void space is enclosed by the secondary battery cells and the spaced-apart tabs located on the thermally conductive member and the side cover member, respectively.

This serves to support a plurality of the secondary battery cells C stacked and mounted on the cell-seating unit 10 in a procumbent state in a height direction.

That is, a plurality of the secondary battery cells C stacked in a height direction of the middle plate member 13 are seated on the support tab 22b neighboring a top portion, and this enables to support a plurality of the secondary battery cells C stacked in the height direction of the cell-seating unit 10 in a procumbent state at a height at which each secondary battery cell C is located.

In other words, a secondary battery cell C located in a lower portion, among a plurality of the secondary battery cells C stacked in the height direction of the cell-seating unit 10, is pressed by a secondary battery cell C disposed in an upper portion, which may create a problem in which the secondary battery cells C may be ruptured. In the present disclosure, however, each secondary battery cell C is supported by the support tab 22b in terms of weight, such a problem in which a secondary battery cell C positioned below a neighboring cell may be pressed and burst can be prevented.

According to the aforementioned example embodiments, the cell-seating unit of the present disclosure and the battery module including the same is advantageous in that a degree of freedom in height direction design changes can be secured. This leads to an effect of increased efficiency in space utilization when installing a secondary battery cell.

In another aspect, the cell-seating unit and the battery module including the same is advantageous in that rigidity can be reinforced by a structure thereof without any additional configuration. This leads to an effect of securing durability while reducing an overall weight thereof.

Further, the cell-seating unit and the battery module including the same is advantageous in that heat dissipation performance due to a heat sink may be improved.

Various advantages and beneficial effects of the present disclosure are not limited to the above descriptions and may be easily understood in the course of describing the specific embodiments of the present disclosure.

While the example embodiments have been shown and described above, it will be apparent to those skilled in the art that modifications and variations could be made without departing from the scope of the present invention as defined by the appended claims.

What is claimed is:

1. A battery module, comprising:
a plurality of secondary battery cells;
a cell-seating unit equipped with the secondary battery cells in a procumbent state;
a cover unit coupled to the cell-seating unit and covering an opening of the cell-seating unit in which the secondary battery cells are accommodated and
wherein the cell-seating unit comprises:
a lower plate member in which a secondary battery cell is seated while being in contact with a portion of a side surface portion of a lowermost secondary battery cell;
an upper plate member disposed to face the lower plate member; and
a middle plate member coupled to the lower plate member and the upper plate member for connection thereof while being in contact with a bottom portion of the secondary battery cells;
wherein the middle plate member is coupled to the bottom portion of the secondary battery cells, mediated by a thermally conductive member,
wherein the thermally conductive member is formed to have a shape corresponding to a shape of a plurality of bottom portions of a plurality of secondary battery cells enabling the plurality of bottom portions of the plurality of secondary battery cells to be inserted thereinto and to support the plurality of secondary battery cells,
wherein the cover unit comprises an end cover member and a side cover member,
wherein the side cover member is provided a plurality of the spaced apart tabs formed to protrude in a direction of the secondary battery cells such that a plurality of the secondary battery cells stacked and accommodated in the cell-seating unit,
wherein the plurality of the spaced apart tabs do not extend in an entire length of the side surfaces of secondary battery cells so that the secondary battery cells are spaced apart from each other with a void space between the side surfaces of adjacent secondary battery cells, and
wherein the void space is enclosed by the secondary battery cells and the spaced-apart tabs located on the thermally conductive member and the side cover member, respectively.

2. The battery module of claim 1, wherein the middle plate member is provided with a heat sink configured to release heat transferred from the secondary battery cells.

3. The battery module of claim 1, wherein the middle plate member is bonded to a central portion between the upper plate member and the lower plate member form a “I” shape, and both sides of the middle plate member contact the bottom portion of the secondary battery cells, and
wherein two separated accommodation spaces are formed at both sides of the middle plate member, each accommodation space accommodating secondary battery cells.

4. The battery module of claim 1, wherein the lower plate member and the upper plate member facing each other in parallel are vertically coupled to both end portions of the middle plate member.

5. The battery module of claim 1, wherein the cell-seating unit is provided with the middle plate member at a height corresponding to a stacking height of a plurality of the secondary battery cells stacked to be accommodated and accommodate a plurality of the secondary battery cells in a region formed by the lower plate member, the upper plate member and the middle plate member.

6. The battery module of claim 4, wherein the thermally conductive member is formed of at least one of silicon, polyurethane and an epoxy material such that the secondary battery cells are bonded thereto.

7. The battery module of claim 1, wherein the cover unit comprises:
the end cover member coupled to both end portions of the middle plate member; and
the side cover member disposed to face the middle plate member and coupled to edge portions of the upper plate member and the lower plate member.

8. The battery module of claim 7, wherein both end portions of the side cover member are inserted into coupling grooves formed in the upper plate member and the lower plate member.

9. The battery module of claim 8, wherein the side cover member is provided with a coupling tap protruded from both end portions thereof in the form corresponding to the coupling groove.

10. The battery module of claim 1, wherein the cell-seating unit is disposed by stacking a pouch-type secondary battery cells three-surface-sealing and accommodating an electrode assembly.
